(19) United States
(12) Patent Application Publication
(10) Pub. No.: US 2019/0009848 A1
(43) Pub. Date: Jan. 10, 2019

(54) WHEEL FOR A HUMAN-POWERED VEHICLE

(71) Applicant: YVOLVE SPORTS LIMITED, Dublin (IE)

(72) Inventors: James A. Long, Devizes (GB); Alexander C.H. Hanson, Altrincham (GB); Robert G. Bodill, Woodstock (GB)

(21) Appl. No.: 15/752,501

(22) PCT Filed: Aug. 15, 2016
(86) PCT No.: PCT/EP2016/069345

§ 371 Date: Feb. 13, 2018

(30) Foreign Application Priority Data
Aug. 13, 2015 (GB) 1514366.2

(51) Int. Cl. B62H 7/00; B60B 27/02; B60B 3/08; B60B 25/00; F16F 15/31; F16F 15/315

(52) U.S. Cl. CPC B62H 7/00; B60B 27/023; B60B 3/085; B60B 25/004; F16F 2232/02; F16F 15/315; F16F 2222/08; F16F 2230/0011; F16F 15/31

(57) ABSTRACT

In an aspect, there is provided a wheel for a human-powered vehicle, comprising a wheel hub (6) rotatably mountable on a central axle (5) defining a wheel rotation axis, a first cover (1) secured to the wheel hub, a circumferential rim (1c) structured to fully support a tyre (4) thereon, and a second cover (2) secured to one of the wheel hub and the first cover adjacent the wheel hub, and mating with the first cover distal from the wheel hub.

### CROSS-REFERENCE TO RELATED APPLICATIONS

This application claims the benefit of British Patent Application No. 1514366.2, filed Aug. 13, 2015, the contents of which are incorporated herein by reference in their entirety.

### FIELD

The present invention relates generally to vehicles, and, in particular, to a wheel for a human-powered vehicle therefor.

### BACKGROUND OF THE DISCLOSURE

When people are learning to ride a bike, they must acquire the reflex skills to steer the bicycle to maintain its orientation with respect to the ground so that the centre of gravity of the bicycle and the rider together is in equilibrium, either central if going in a straight line, or displaced towards the centre of any cornering arc. Gyroscopic precession is a phenomenon that has long been used to stabilise the balance of objects and it has long been understood that all bicycle wheels have an inherent gyroscopic effect themselves that helps to balance a bike which is greater when they are large and heavy.

Some proposed devices supplement the gyroscopic effect of the bicycle wheels for the purposes of balance training and assisted bicycle riding with an additional gyroscope contained around the bicycle or within the wheel that is purposefully heavy and rotates at greater speed than the bicycle wheel. Furthermore, they describe that if this additional gyroscope rotates coaxially and in the same rotational direction as the front wheel of the bicycle then on becoming imbalanced, the precession effect of the gyroscope also induces the correct direction of steering to help restore balance equilibrium. The gyroscopic effect can be reduced by reducing the speed of rotation as the learner adopts the balancing reflex until such time that it may no longer be required.

The gyroscopic element of these devices, such as a disc or spoked flywheel with mass concentrated towards its outer region, must rotate quickly to provide sufficient gyroscopic effect. For the wheel to be safe in use, this disc or flywheel is contained within the bicycle wheel and fits within the space available between existing bicycle front forks and the front brakes. The outer covers of the wheel have been made in two similar circular parts which are affixed together to enclose the gyroscopic disc and to support the tyre by each cover supporting one side of the tyre side wall and edge. The two circular parts define an axis of the bicycle wheel and the gyroscopic disc or flywheel between the two circular halves, which may not be well aligned. In addition, it also subjects the mechanical fixings of the covers to the pressure contained within the tyre if pneumatically inflated. Furthermore, the gyroscope is contained within the wheel such that it requires skill to remove, and if not removed, the wheel remains heavy and is less preferable for bicycle riding if the gyroscopic effect is no longer required for training purposes. Still further, the split rim provided by the two circular parts is held together around the outer diameter by screws. This leads to stress concentrations around the fasteners.

The motive means to accelerate and maintain a fast rotating gyroscope are preferably small in size and without undue frictional and efficiency losses that act to limit the maximum terminal speed of the gyroscope and therefore its beneficial effect. Some systems described in the above-identified references transfer rotation from an electrical motor contained within the training wheel to a flat surface on the gyroscopic disc by the use of a smooth wheel attached to the motor shaft on which is retained in a channel a separable rubber or elastomer toroid with a smooth surface. The motor wheel and toroid are pushed against the gyroscopic disc by means of mechanical springs and the motion is constrained by a member which deflects in an axis perpendicular and tangential to the axis of rotation of the gyroscopic disc. A problem with this arrangement is that the toroid is subject to its own inertial forces of rotation which limit its speed and the geometry of contact when acted upon by the mechanical spring leads to rapid wear through compression and friction and consequential loss of operation.

Another existing system requires electrical input to accelerate and then maintain the rotational speed of the gyroscopic disc that is then lost when the device is no longer used.

The heavy mass of a gyroscopic disc or flywheel is an inconvenience to a bicycle user that no longer requires the gyroscopic effect.

### SUMMARY OF THE DISCLOSURE

According to an aspect, there is provided a wheel for a human-powered vehicle, comprising a wheel hub rotatably mountable on a central axle defining a wheel rotation axis, a first cover secured to the wheel hub and comprising a circumferential rim structured to fully support a tyre thereon, and a second cover secured to one of the wheel hub and the first cover adjacent the wheel hub, and mating with the first cover distal from the wheel hub.

The first cover can comprise the circumferential rim coupled to a separate disc portion.

The second cover can be releasably secured to the one of the wheel hub and the first cover. The second cover can comprise a first circumferential rib that snugly abuts the circumferential rim when the second cover is secured to the one of the wheel hub and the first cover. The second cover can further comprise a second circumferential rib concentric with and adjacent to the first circumferential rib defining a circumferential groove that snugly receives the circumferential rim.

The first cover and the second cover can define an enclosure therebetween.

The wheel can further comprise a flywheel structure positioned in the enclosure, comprising a flywheel extending from a collar rotatably coupled to the wheel hub enabling rotation of the flywheel generally about the wheel rotation axis. The flywheel can be releasably secured to the collar. Alternatively, the flywheel structure is releasably coupled to the wheel hub.

A seal between the first cover and the second cover can be water-resistant.

The wheel can further comprise a flywheel drive positioned to drive the flywheel, and a control circuit coupled to the flywheel drive to control operation thereof.

The wheel can further comprise a separation detection mechanism that detects the separation of the second cover from the first cover, the separation detection mechanism being coupled to the control circuit to cause the control circuit to one of terminate operation of the flywheel drive and generate resistance to continued rotation of the flywheel when the second cover is separated from the first cover.

The control circuit can comprise a resistor that generates resistance to continued rotation of the flywheel when the second cover is separated from the first cover.

The first cover can comprise a pair of electrical contacts coupled to the control circuit, and the second cover can comprise an electrical bridging contact that bridges the pair of electrical contacts on the first cover when the second cover is secured against the first cover, the control circuit causing one of the termination of the operation of the flywheel drive and the generation of resistance to continued rotation of the flywheel when the electrical contacts are unbridged.

The separation detection mechanism can comprise an optical sensor positioned in the enclosure and coupled to the control circuit, the optical sensor, in response to detecting the presence of a threshold level of light, causing the control circuit to one of terminate the operation of the flywheel drive and generate resistance to continued rotation of the flywheel.

The separation detection mechanism can comprise an optical sensor positioned in the enclosure and coupled to the control circuit, wherein the flywheel has an aperture that periodically aligns with the optical sensor when the flywheel is rotating, the optical sensor, in response to detecting a pattern of light, causing the control circuit to one of terminate the operation of the flywheel drive and generate resistance to continued rotation of the flywheel.

The wheel can further comprise a manual power button for controlling the control circuit.

The wheel can further comprise a flywheel drive operable to apply a torque to a drive wheel positioned against the flywheel to drive the flywheel, the drive wheel having a drive rotation axis that is generally perpendicular to the wheel rotation axis, the drive wheel having a bevelled edge, and a bevelled surface on the flywheel generally extending along a line from an intersection point between the drive rotation axis and the wheel rotation axis.

At least one of the bevelled edge of the drive wheel and the bevelled surface of the flywheel can be comprised of one of a rubber, a polymer, and an elastomer.

The wheel can further comprise a suspension chassis to which the flywheel drive is secured, the suspension chassis biasing the flywheel drive towards the flywheel.

The suspension chassis can be pivotable about a pivot that is generally perpendicular to the wheel rotation axis.

The suspension chassis can be biased by a spring.

Pivoting of the suspension chassis towards the flywheel can be limited by a stop.

According to another aspect, there is provided a wheel for a human-powered vehicle, comprising a flywheel having a flywheel rotation axis, a flywheel drive applying a torque to a drive wheel for driving the flywheel, the drive wheel having a drive rotation axis that is generally perpendicular to the wheel rotation axis, the drive wheel having a bevelled edge, and a bevelled surface on the flywheel generally extending along a line from an intersection point between the drive rotation axis and the wheel rotation axis.

At least one of the bevelled edge of the drive wheel and the bevelled surface of the flywheel can be comprised of one of a rubber, a polymer, and an elastomer.

The wheel can further comprise a position adjustment mechanism to which the flywheel drive is secured, the position adjustment mechanism positioning the flywheel drive in contact with the flywheel.

The position adjustment mechanism can comprise a pivot that is generally perpendicular to the wheel rotation axis.

The position adjustment mechanism can comprise a spring.

Pivoting of the flywheel drive towards the flywheel can be limited by a stop.

According to a further aspect, there is provided a wheel for a human-powered vehicle, comprising a flywheel structure, comprising a collar rotatably mountable on a wheel hub, and a flywheel releasably secured to the collar.

The flywheel can be releasably secured to the collar via at least one fastener.

The flywheel can be releasably secured to the collar via a clip.

According to yet another aspect, there is provided a wheel for a human-powered vehicle, comprising a wheel structure, a flywheel positioned within the wheel structure, a flywheel drive positioned to drive the flywheel, a control circuit coupled to the flywheel drive to control operation thereof, a cover removably secured to the wheel structure and providing access to the flywheel, and a separation detection mechanism that detects the removal of the cover, the separation detection mechanism being coupled to the control circuit to cause the control circuit to one of terminate operation of the flywheel drive and generate resistance to continued rotation of the flywheel when the cover is removed from the wheel structure.

The control circuit can comprise a resistor that generates resistance to continued rotation of the flywheel when the cover is removed from the wheel structure.

The wheel structure can comprise a pair of electrical contacts coupled to the control circuit, and the cover can comprise an electrical bridging contact that bridges the pair of electrical contacts on the wheel structure when the cover is secured against the wheel structure, the control circuit causing one of the termination of the operation of the flywheel drive and the generation of resistance to continued rotation of the flywheel when the electrical contacts are unbridged.

The separation detection mechanism can comprise an optical sensor positioned in an enclosure defined by the wheel structure and the cover and coupled to the control circuit, the optical sensor, in response to detecting the presence of a threshold level of light, causing the control circuit to one of terminate the operation of the flywheel drive and generate resistance to continued rotation of the flywheel.

The separation detection mechanism can comprise an optical sensor positioned in an enclosure defined by the wheel structure and the cover and coupled to the control circuit, wherein the flywheel has an aperture that periodically aligns with the optical sensor when the flywheel is rotating, the optical sensor, in response to detecting a pattern of light, causing the control circuit to one of terminate the operation of the flywheel drive and generate resistance to continued rotation of the flywheel.

The wheel can further comprise a manual power button for controlling the control circuit.

### BRIEF DESCRIPTION OF THE DRAWINGS

Embodiments will now be described, by way of example only, with reference to the attached Figures, wherein:

FIG. 1 shows a cut-away sectional view of a gyroscopic bicycle wheel I accordance with an embodiment;

FIG. 2a is a sectional view of a radial periphery of the gyroscopic bicycle wheel, including a tyre positioned on a first cover and the joint between the first cover and a second cover;

FIG. 2b shows a sectional view of a radial periphery of a gyroscopic bicycle wheel in accordance with another embodiment, wherein seating for a tyre is provided entirely by a separate rim portion;

FIG. 3 shows releasable securing fasteners for releasably retaining a gyroscopic disc and one of the covers of the gyroscopic bicycle wheel of FIG. 1 on a hub;

FIG. 4 shows a driving wheel driving the flywheel of the gyroscopic bicycle wheel of FIG. 1;

FIG. 4a shows a driving wheel driving a flywheel in accordance with another embodiment;

FIG. 5 shows a sprung suspension for biasing the driving wheel towards the flywheel in the gyroscopic bicycle wheel of FIG. 1;

FIG. 6 shows an optical sensor of the gyroscopic bicycle wheel for detecting the absence of the second cover of the gyroscopic bicycle wheel;

FIG. 7 shows another separation detection mechanism for detecting the separation of the second disc cover from the first disc cover; and

FIGS. 8a and 8b show a circuit for recovering energy from the rotating flywheel to recharge an energy storage device of the gyroscopic bicycle wheel of FIG. 1.

### DETAILED DESCRIPTION OF THE EMBODIMENTS

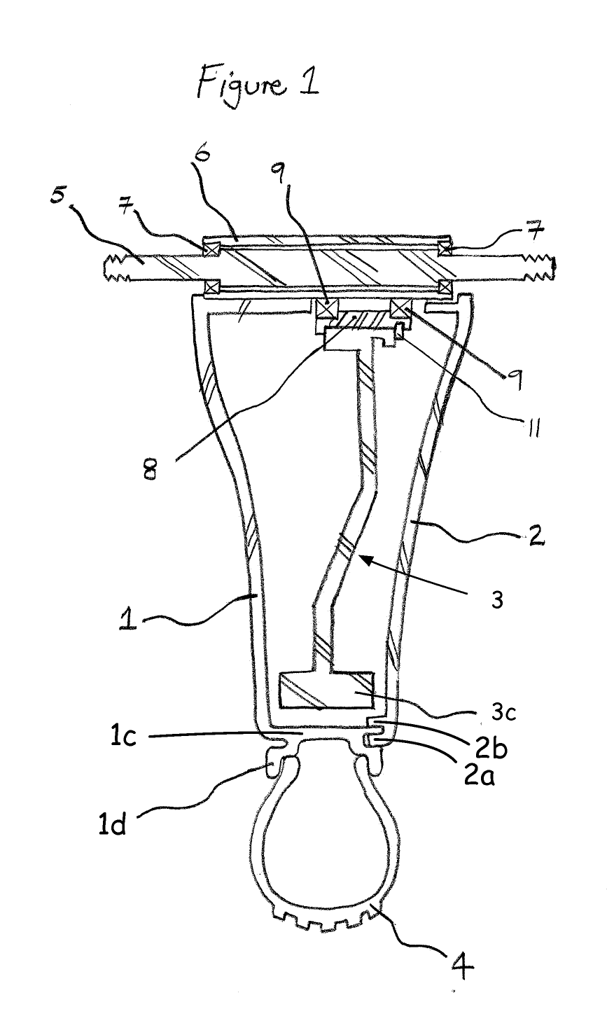

FIG. 1 shows a portion of a gyroscopic bicycle wheel 100 in accordance with an embodiment. The gyroscopic bicycle wheel 100 has a first disc cover 1 that, together with a second disc cover 2, defines an enclosure in which a flywheel structure 3 is disposed. The first disc cover 1 and the second disc cover 2 are made from plastic, but can also be made from another suitably light and rigid material, such as aluminium. The flywheel structure 3 includes a flywheel 3c having a large portion of its weight located distal from the rotation axis along its periphery, and is made integrally of a metal. The greater the weight and its distance from the rotation axis, the greater the gyroscopic effect. In other embodiments, the flywheel 3c is compositely manufactured, or can be any suitable configuration of a rotating mass energy storage device. A central fixed axle 5 of the gyroscopic bicycle wheel 100 may be fixed into a bicycle's frame forks (not shown) according to the normal accepted methods of retaining nut, quick-release cams, or skewers. Coaxially on the central fixed axle 5 is arranged a wheel hub 6 that is able to rotate freely around the central fixed axle 5, and is supported by two bearings 7 retained in place via press-fitting towards each lateral end of the wheel hub 6. The tubular wheel hub 6 is used to give the gyroscopic bicycle wheel 100 the maximum bearing width whilst also allowing the flywheel structure 3 to be mounted thereon. In other embodiments, one or more sets of bearings and/or one or more bushes can be used to enable the wheel hub to rotate freely in relation to the central fixed axle 5. Distal placement of the sets of bearings enables better coaxial alignment between the central fixed axle 5 and the wheel hub 6.

The first disc cover 1 is affixed to the wheel hub 6 in such a manner that they only rotate coaxially about the central fixed axle 5 and to such an extent that the first disc cover 1 is coupled to the wheel hub 6 for part of its length from one end to approximately the middle of the length of the wheel hub 6. The first disc cover 1 has a circumferential rim lc monolithically formed therein that is structured to fully support a tyre thereon. In particular, the circumferential rim 1c has a generally flat lateral cross section with a pair of circular rim flanges 1d extending generally radially therefrom. The rim flanges 1d retain the beads of a tyre 4 between them.

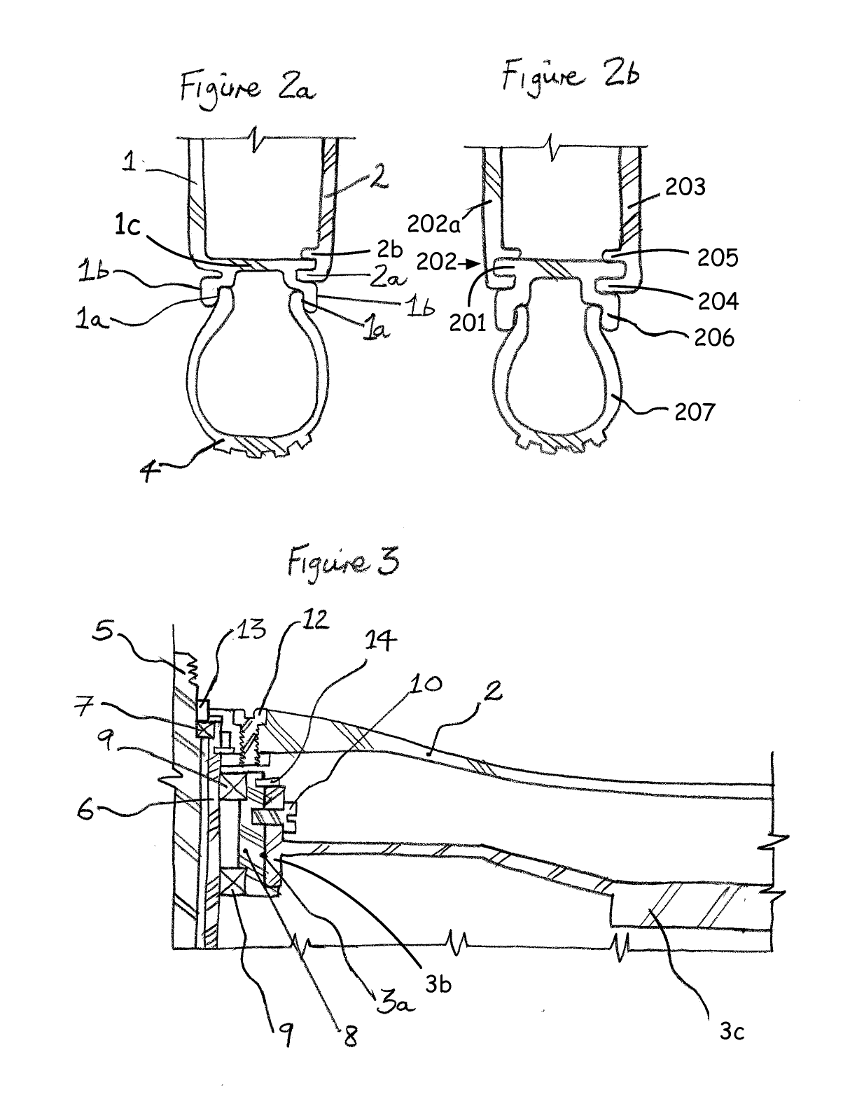

FIG. 2a shows the tyre 4 seated and retained by the rim flanges 1d of the first disc cover 1 in greater detail. In particular, the beads of the tyre 4 are pushed against opposing inner surfaces 1a of the rim flanges 1d by an inflated inner tube (not shown) positioned inside the tyre 4. Laterally external rim braking surfaces 1b of the rim flanges 1d provide friction surfaces for the application of bicycle brakes, such as the typical calliper style. The dimensions of the rim flanges 1d can be varied as required, depending on the configuration.

Referring now to FIGS. 1 and 2a, the second disc cover 2 is secured adjacent the wheel hub 6 and has a first continuous circumferential rib 2a and preferably a second continuous circumferential rib 2b spaced inside and concentric with the circumferential rib 2a. The first circumferential rib 2a and the second circumferential rib 2b can cooperate to form a circumferential groove that snugly receives the circumferential rim 1c of the first disc cover 1 on assembly to provide a closed and strong structure to the gyroscopic bicycle wheel 100. The first disc cover 1 and the second disc cover cooperatively provide a water-resistant seal between them to protect any components in the enclosure from the elements.

FIG. 2b shows an alternative construction wherein a circumferential rim 201 is coupled with a separate disc portion 202a in the first cover 202. Both the disc portion 202a and a second disc cover 203 have a first continuous circumferential rib 204 and a second continuous circumferential rib 205 spaced inside and concentric with the first circumferential rib 204 so that they cooperate to provide a circumferential groove that snugly receives the circumferential rim 201. The circumferential rim 201 has two rim flanges 206 that act to retain the beads of a tyre 207 via inside lateral surfaces thereof and provide external breaking surfaces.

FIG. 3 shows the securing of the flywheel structure 3 to the wheel hub 6 in greater detail. The flywheel structure 3 is made from a heavy material, such as metal. For the ease of manufacture and so that the flywheel 3c might be removed from the gyroscopic bicycle wheel 100 more easily, the flywheel 3c has a sleeve 3b that is secured to a collar 8, which is coaxial to the central fixed axis 5 and the wheel hub 6, thus aligning the rotation axis of the flywheel 3c with the rotation axis of the gyroscopic bicycle wheel 100. The collar 8 is generally tubular and has a set of bearings 9 at opposite lateral ends thereof that enable its free rotation about the outer circumferential surface of the wheel hub 6. In other embodiments, one or more bearings and/or bushes can be used to enable the collar to rotate freely around the wheel hub. Preferably, the bearings and/or bushings are spaced apart along the rotation axis of the wheel hub to provide better coaxial alignment with the wheel hub and the central fixed axle. This facilitates avoidance of accidental contact between the flywheel 3c and the first disc cover 1 and the second disc cover 2, and thus enables tighter tolerances in the dimensions of the flywheel 3c and the disc covers 1 and 2.

The sleeve 3b of the flywheel 3c is fitted on a substantially conical or cylindrical surface 3a of the collar 8 such that the collar 8 may or may not remain in place when the flywheel 3c is removed. A threaded bolt 10 and a clip 14 are used to retain the flywheel structure 3 in place. In other embodiments, one or more bolts or clips, an adhesive, or any other suitable means to secure the flywheel 3c to the collar 8 can be used. It can be preferable that the means for securing the flywheel 3c to the collar 8 are releasable.

The second disc cover 2 is releasably secured in place on the wheel hub 6 similarly by means that may include a threaded bolt 12 or a clip 13, or both, or other such familiar means of retention. In some cases, such as where the first disc cover 1 extends across a large portion of the wheel hub 6, it can be desirable to releasably secure the second disc cover 2 to the first disc cover 1 adjacent the wheel hub 6. When the second disc cover 2 is secured in place, the circumferential rim 1c of the first disc cover 1 is snugly received between the first circumferential rib 2a and the second circumferential rib 2b of the second disc cover 2 about its circumference, providing a rigid wheel structure that distributes stress about its circumference.

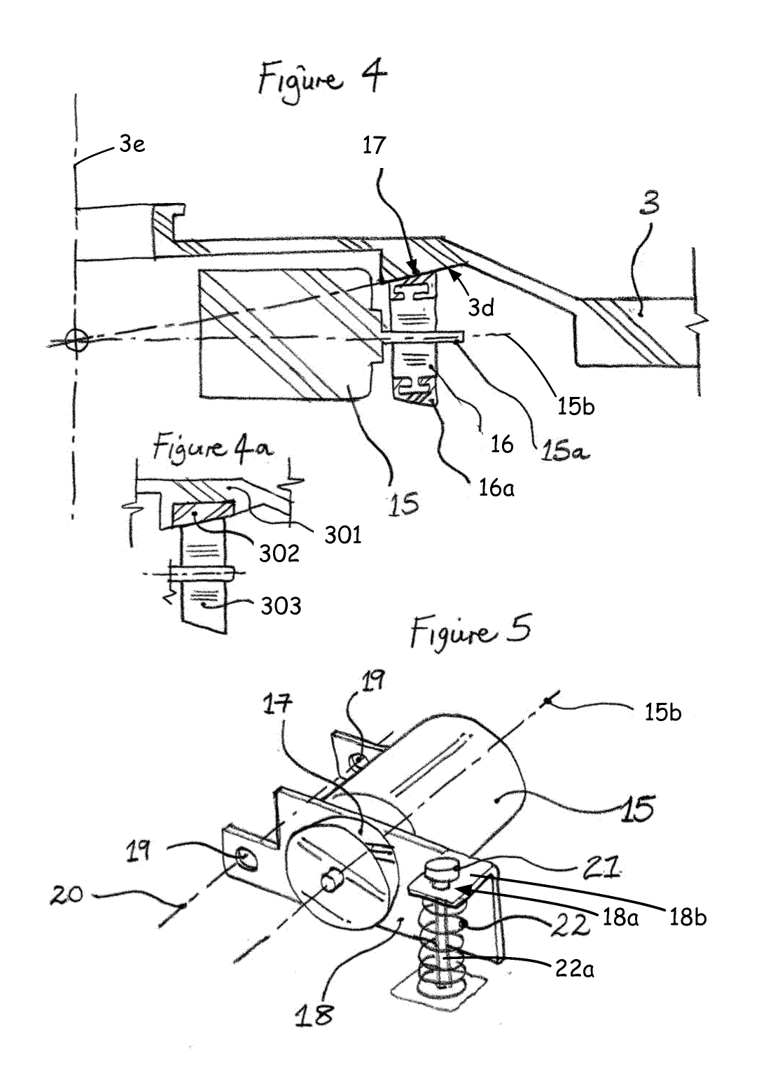

FIG. 4 shows a drive assembly for driving the flywheel 3c to rotate it around the rotation axis of the gyroscopic bicycle wheel 100. The drive assembly includes a flywheel drive 15 that is mounted on an inside surface of the first disc cover 1 for imparting torque to a drive shaft 15a that is generally perpendicular to the flywheel. The flywheel drive 15 can be, for example, an electrical or fluid powered drive motor. A drive wheel 16 is affixed to the drive shaft 15a and has a drive rotation axis 15b that is generally perpendicular to the wheel/flywheel rotation axis 3e. The drive wheel 16 may be metal, a polymer, or another suitable substance.

If a straight-edged drive wheel was employed with the flywheel 3c, with the centre of the wheel running at the same speed of the flywheel 3c then the top half of the drive wheel would be moving more slowly than the flywheel 3c whilst the bottom half of the drive wheel would be moving more quickly. This difference in speed would lead to slip resulting in wear and friction between the drive wheel and the flywheel 3c. In order to reduce this slip, the drive wheel 16 has a bevelled edge 17 and the flywheel 3c has a corresponding bevelled surface 3d, which allow the drive wheel 16 to have approximately the same speed as the flywheel 3c across the whole contact region between the two surfaces.

The drive wheel 16 has an elastomeric, polymeric or rubber outer layer 16a which is terminated by an outer frustoconical or bevelled drive wheel edge 17 that corresponds to a corresponding frustoconical or bevelled flywheel surface 3d on the flywheel 3c such that a contact region is established therebetween. The width of the drive wheel edge 17 is in contact with the bevelled surface 3d of the flywheel 3c, and provides sufficient friction and continuous meshing together with the bevelled flywheel surface 3d with low wear. The outer layer 16a is attached to the drive wheel 16 by adhesive or an enveloping geometry, but preferably by inserting the drive wheel 16 in an over-moulding process that forms an inseparable engagement and encapsulation of the drive wheel 16 by the outer layer 16a, as shown. The bevelled drive wheel edge 17 and the bevelled flywheel surface 3d are arranged such that the contact region therebetween extends along a line extrapolated from the intersection of the rotation axis of both the collar 8 of the flywheel structure 3 and the drive wheel 16 in a manner familiar to the design of bevel gears.

FIG. 4a shows an alternative construction wherein a drive wheel 303 is solid and made from a material such as a polymer or metal and cooperates with a less hard polymeric or elastomeric surface 302 placed on or embedded within a frustoconical/bevelled surface of a flywheel 301.

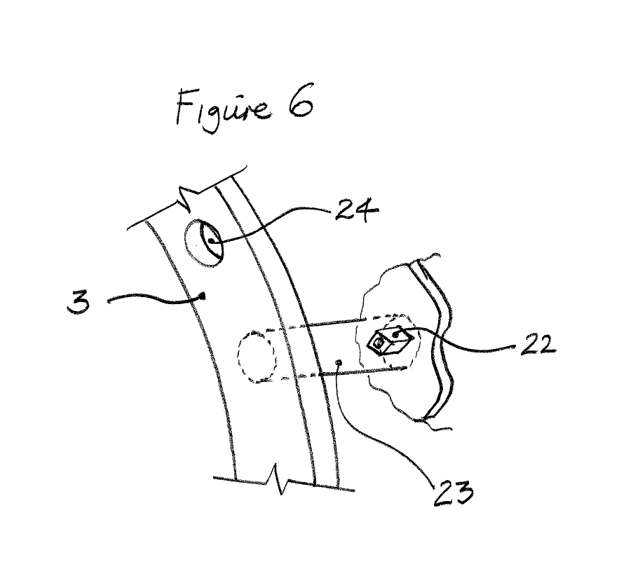

FIG. 5 shows a suspension chassis 18 to which the flywheel drive 15 is attached. The suspension chassis 18 has two coaxial pivot holes 19 spaced apart on a common pivot axis 20. The first disc cover 1 (FIG. 2a) has a pivot rod that is received by the pivot holes 19, enabling the suspension chassis to pivot therearound. In other embodiments, the suspension chassis 18 can be attached to one or more pivot mechanisms. The pivot mechanisms can be any one of a number of suitable types, such as, for example, piano hinges. A through-hole 18a in a flange tab 18b of the suspension chassis 18 receives a spring rod 22a extending from the first disc cover 1. A spring 22 positioned over the spring rod 22a pushes against the flange tab 18b of the suspension chassis 18 to bias the flywheel drive 15 attached to the suspension chassis 18, and thus the drive wheel edge 17, into continuous contact with the bevelled disc surface 3d of the flywheel 3c. A piece of foam is mounted inside the spring 22 to dampen any deflection of the spring 22 due to impacts to the first disc cover 1. In this manner, when the drive wheel edge 17 is in contact with the bevelled disc surface 3d, the force of contact is sufficient only to transfer rotation without slippage between the drive wheel edge 17 and the flywheel 3c. A spring rod cap 21 on the end of the spring rod 22a retains the suspension chassis 18 on the spring rod 22a. The spring rod cap 21 and the spring rod 22a may be integrally formed as a bolt or may be coupled together such as via mating threaded surfaces or another suitable manner. Spring rod cap 21 acts as a stop to limit excessive motion of the suspension chassis 18 that might otherwise place the drive wheel edge 17 in contact with the second disc cover 2 when the flywheel 3c is absent prior to full assembly of the gyroscopic bicycle wheel 100. The pivots 19 are secured directly or indirectly on the first disc cover 1 to provide limited rotation about the pivot axis 20 that lies generally parallel to the drive shaft 15a of the flywheel drive 15. Various other suitable types of position adjustment mechanisms can be employed to bias the drive wheel 16 against the flywheel 3c, such as, for example, a non-pivoting spring suspension or a slotted aperture.

When spinning at its top speed, the flywheel 3c has a lot of kinetic energy and, on its own, would take several minutes to slow down as the only losses are due to friction and air resistance. This is inconvenient for the user as it makes the wheel difficult to handle (i.e., it makes it difficult to control the steering the bicycle to the right or left). To address this, the gyroscopic bicycle wheel 100 employs an electronic brake to slow the flywheel 3c. The electronic brake can be activated via a manual power button on an exterior surface thereof. In addition, the electronic brake is activated when it is determined by a separation detection mechanism that the second disc cover 2 is absent. This is done both optically and electrically.

FIG. 6 shows a first separation detection mechanism; more specifically, an optical sensor 22 positioned on the interior of the first disc cover 1 to have a lateral line of sight. The optical sensor 22 can detect patterns of changes in the level of light. A tube 23 blocks extraneous light between the optical sensor 22 and the surface of the flywheel 3c peripheral to the line of sight of the optical sensor 22. A flywheel hole 24 in the flywheel 3c periodically aligns with the line of sight of the optical sensor 22 when the flywheel 3c is rotated. In other embodiments, two or more disc holes can be distributed circumferentially about the flywheel 3c, or the line of sight of the optical sensor 22 can be directed at a portion of a flywheel that has spokes. While the flywheel hole 24 is shown as being dimensioned to match the profile of the tube 23, the dimension of the flywheel hole 24 can be larger or smaller, or varied in some other manner. If the second disc cover 2 is removed while the flywheel 3c is rotating, the optical sensor 22 will detect ambient light through the flywheel hole 24 when it aligns with the opening at the top of the tube 23 and will otherwise detect a darker light level when the flywheel hole 24 is not aligned with the optical sensor 22. The pattern of changes in the level of light can be detected by determining light level differences over time periods and identifying changes exceeding a threshold as a change to light or dark accordingly. The regularity of the period of the changes can also be considered in determining whether the pattern corresponds to the separation of the second disc cover 2 from the first disc cover 1.

Upon detecting a pattern of light and darkness via the optical sensor 22, the flywheel drive 15 can apply braking to the flywheel 3c to stop its rotation as it might be hazardous to the gyroscopic bicycle wheel 100 or to other neighbouring objects, animals, and/or people. In another embodiment, an optical sensor positioned in the enclosure can detect a threshold level of light indicative of the absence of the second disc cover 2 and control operation of the flywheel drive accordingly via a control circuit to which it is coupled.

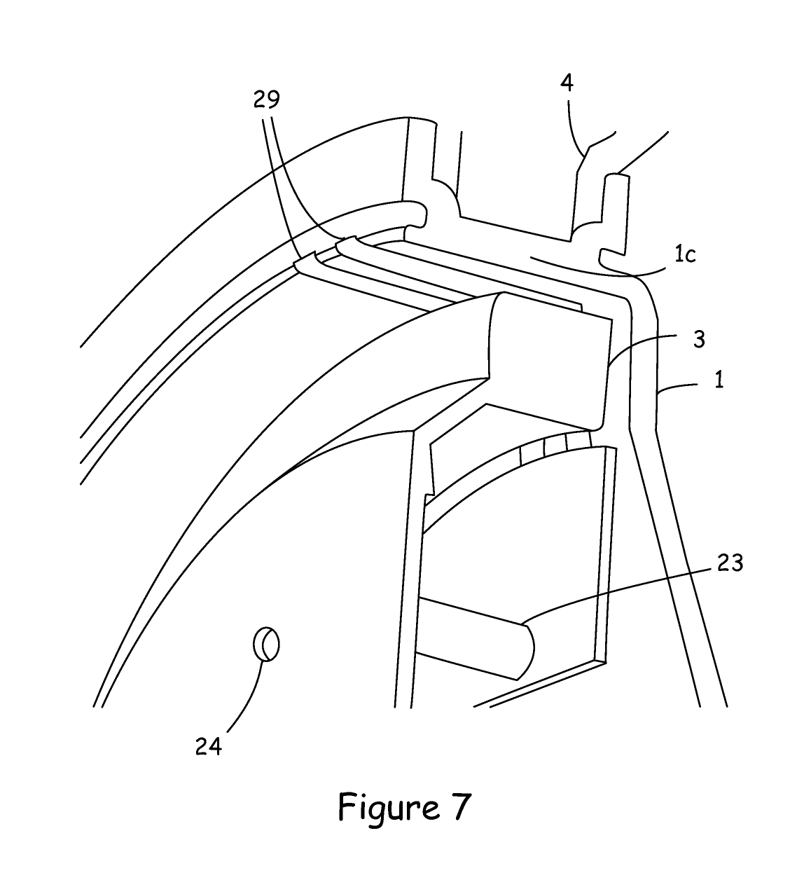

FIG. 7 shows another separation detection mechanism that electrically determines when the second disc cover 2 is absent. In particular, two electrical contacts 29 made of sprung metal extend from an electrical control circuit and generally radially along an interior surface of the first disc cover 1 and its circumferential rim 1c. The second disc cover 2 has a corresponding electrical bridging contact for bridging between the two electrical contacts 29 and completing a circuit, thereby notifying the electrical control circuit. Removal of the second disc cover 2 opens the circuit, thereby causing the electrical control circuit to cease powering the flywheel drive 15 and apply braking to the flywheel 3c. Where the corresponding metal contact on the second disc cover 2 does not extend around the full circumference of the second disc cover 2, it is desirable to provide guidance to a user to orient the second disc cover 2 correctly when securing it to the first disc cover 1. The first disc cover 1 and the second disc cover 2 can have a visual and or physical mating features, such as a notch and corresponding protrusion, to guide the user in their relative orientation.

Absence of the second disc cover 2 can be detected in other ways, such as, for example, the use of a magnetic element in the second disc cover 2 and a corresponding Hall sensor in the first disc sensor 1. In another example, the first disc cover 1 can include a mechanical switch that is actuated by a physical element of the second disc cover 2 when positioned adjacent the first disc cover 1.

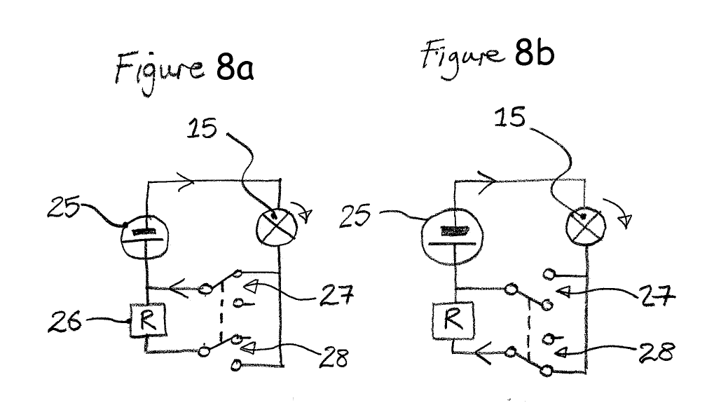

FIGS. 8a and 8b show the electrical control circuit that is electrically coupled to the manual power button, the optical sensor 22, and the two electrical contacts 29 on the first disc cover 1. The electrical control circuit comprises an electrical energy store 25 that is connected electrically to a first switch 27 and a second switch 28, a voltage regulator device 26 and the flywheel drive 15. The electrical energy store 25 can be, for example, a battery or other suitable mechanism/device for storing electrical energy. The voltage regulator device 26 can be, for example, a voltage regulator circuit or any other suitable means to regulate the voltage. When the first switch 27 is closed and the second switch 28 is open, as shown in FIG. 8a, power is delivered to operate the flywheel drive 15, which, in turn, rotates the flywheel 3c by the means earlier described. When, instead, the gyroscopic effect is no longer required or desired, the first switch 27 is opened and the second switch 28 is closed, as shown in FIG. 8b. The kinetic energy within the flywheel 3c drives the flywheel drive 15 to create power that is directed through the voltage regulator device 26 to recharge the electrical energy store 25 whilst also slowing the rotation of the flywheel 3c conveniently, causing the flywheel 3c to more quickly to stop its rotation.

The first disc cover 1 of the gyroscopic bicycle wheel 100 can support the tyre 4 fully on its circumferential rim 1c, enabling some control over the transmission the forces applied by the weight of the bicycle and user via the central fixed axis 5 of the gyroscopic bicycle wheel 100 by means of the rotating wheel hub 6 to which the first disc cover 1 is affixed through to the circumferential rim 1c around which the tyre 4 is positioned. This spreads the stress from the tyre pressure around the whole circumference of the gyroscopic bicycle wheel 100, leading to a stronger wheel. Thus, the first disc cover 1 is effectively the wheel structure, and the first disc cover 1 and the second disc cover 2 enclose the flywheel structure 3, control electronics, and the flywheel drive 15, sealing them from the environment and generally preventing users from accessing the spinning flywheel 3c. Furthermore, the construction allows the flywheel 3c to be more readily removed upon prior removal of a single cover, specifically the second disc cover 2 in the example shown. This can be done without need to remove any bearings. Further, there can be a static seal between the first disc cover 1 and the second disc cover 2, and only the smallest bearings need to be sealed.

Referring again to FIG. 3, the flywheel 3c has a mass of several kilograms, making the gyroscopic bicycle wheel 100 somewhat heavier than a standard bicycle wheel. Once the flywheel 3c has served its purpose (e.g., the user has finished learning to ride a bicycle using the wheel), it can be desirable to reduce the total mass of the gyroscopic bike wheel 100 by allowing the user to remove the flywheel 3c. The design of the gyroscopic bicycle wheel 100 enables the flywheel 3c to be more easily removed without skill and without removing the tyre 4 from the gyroscopic bicycle wheel 100. In order to remove the flywheel 3c, the second disc cover 2 is removed by removing the threaded bolt 12 and/or the clip 13. The threaded bolt 10 and the clip 14 are then removed, enabling the flywheel 3c to be removed from the collar 8 and withdrawn from the gyroscopic bicycle wheel 100. The second disc cover 2 is then refitted onto the first disc cover 1 and the threaded bolt 12 and/or the clip 13 is/are replaced to secure the second disc cover 2 to the first disc cover 1, thus reinforcing the strength of the gyroscopic bicycle wheel 100.

The gyroscopic bicycle wheel 100 is able to provide increased levels of gyroscopic precession through increased rotation speed of the flywheel 3c that need not be heavier or larger. The gyroscopic effect can be maintained for longer periods and for an extended life which improve its effectiveness in training and in providing balance assistance for longer journey and requires shorter energy storage recharge times all other factors being common.

The structure of the circumferential rim can be varied to support different types of tyres. In one embodiment, a valve of the inner tube protrudes through a valve opening in the circumferential rim 1c of the first disc cover 1 and is angled against the inside of the circumferential rim 1c to reduce interference with the flywheel 3c. In another embodiment, an inner tube and corresponding tyre having a valve disposed along its lateral side are employed. In yet another embodiment, tubeless tyres are employed with the gyroscopic bicycle wheel. Where a tubeless tyre is employed, rim flanges can be omitted from the circumferential rim and the tyre can be adhered onto the circumferential rim.

The second disc cover need not be round on its exterior and may take on other shapes, but preferably encloses the flywheel structure.

While the second disc cover extends to the circumference of the first disc cover and the circumferential rim in the above-described embodiments, in other embodiments, it can extend partially to the circumference of the wheel, with one or more features at or close to the periphery of the second disc cover, such as a groove, matching one or more corresponding features on the first disc cover. This configuration can provide a reduced enclosure for movement of a flywheel therein. The second disc cover can be of other shapes, such as square, hexagonal, etc.

The drive rotation axis can, in other embodiments, be generally non-perpendicular to the wheel rotation axis. For example, the bevelling of the drive wheel can be modified to enable the drive rotation axis to be varied without changing the bevelled surface on the flywheel as compared to the bevelled surface shown in the figures.

While, in the above-described embodiments, the flywheel drive is a motor, the flywheel drive can be any suitable mechanism for driving the flywheel. In one alternative embodiment, the flywheel drive is operated by a spring-retracted cord, enabling the flywheel to be manually spun. In another alternative embodiment, the flywheel drive can be spring-driven.

In the above-described embodiments, the manual power button and the separation detection mechanism(s) are coupled to the control circuit to both terminate operation of the flywheel drive and brake the flywheel. In other embodiments, the manual power button and the separation detection mechanism can only perform one of these functions. Further, none, one, or more separation detection mechanisms can be employed to detect the separation of the second disc cover from the first disc cover.

In alternative embodiments, the flywheel structure is retained in place on the wheel hub via a clip or other suitable securing means, and is removed in its entirety from the wheel via removal of the second cover.

While the gyroscopic wheel was described with reference to bicycles, it will be appreciated that the same principles can be applied to other types of wheels for human-powered vehicles, such as tricycles, scooters, or any other suitable type of human-powered vehicle.

In some embodiments, fasteners such as screws can be employed to secure the second disc cover to the first disc cover distal from the wheel hub.

Persons skilled in the art will appreciate that there are yet more alternative implementations and modifications possible, and that the above examples are only illustrations of one or more implementations. The scope, therefore, is only to be limited by the claims appended hereto.

1. A wheel for a human-powered vehicle, comprising:
a wheel hub rotatably mountable on a central axle defining a wheel rotation axis;
a first cover secured to the wheel hub, and comprising a circumferential rim structured to fully support a tyre thereon;
a second cover releasably secured to one of the wheel hub and the first cover adjacent the wheel hub, and mating with the first cover distal from the wheel hub, the first cover and the second cover defining an enclosure therebetween; and
a flywheel structure positioned in the enclosure, comprising a flywheel extending from a collar rotatably coupled to the wheel hub enabling rotation of the flywheel generally about the wheel rotation axis, the flywheel being removable from the wheel hub.

2. A wheel according to claim 1, wherein the first cover comprises the circumferential rim coupled to a separate disc portion.

3. (canceled)

4. A wheel according to claim 1, wherein the second cover comprises a first circumferential rib that snugly abuts the circumferential rim when the second cover is secured to the one of the wheel hub and the first cover.

5. A wheel according to claim 4, wherein the second cover comprises a second circumferential rib concentric with and adjacent to the first circumferential rib defining a circumferential groove that snugly receives the circumferential rim.

6. (canceled)

7. (canceled)

8. A wheel according to claim 1, wherein the flywheel is releasably secured to the collar.

9. A wheel according to claim 1, wherein the flywheel structure is releasably coupled to the wheel hub.

10. A wheel according to claim 8, wherein a seal between the first cover and the second cover is water-resistant.

11. A wheel according to claim 8, further comprising:
a flywheel drive positioned to drive the flywheel; and
a control circuit coupled to the flywheel drive to control operation thereof.

12. A wheel according to claim 11, further comprising:
a separation detection mechanism that detects the separation of the second cover from the first cover, the separation detection mechanism being coupled to the control circuit to cause the control circuit to one of terminate operation of the flywheel drive and generate resistance to continued rotation of the flywheel when the second cover is separated from the first cover.

13. A wheel according to claim 12, wherein the control circuit comprises a resistor that generates resistance to continued rotation of the flywheel when the second cover is separated from the first cover.

14. A wheel according to claim 12, wherein the first cover comprises a pair of electrical contacts coupled to the control circuit, and the second cover comprises an electrical bridging contact that bridges the pair of electrical contacts on the first cover when the second cover is secured against the first cover, the control circuit causing one of the termination of the operation of the flywheel drive and the generation of resistance to continued rotation of the flywheel when the electrical contacts are unbridged.

15. A wheel according to claim 12, wherein the separation detection mechanism comprises an optical sensor positioned in the enclosure and coupled to the control circuit, the optical sensor, in response to detecting the presence of a threshold level of light, causing the control circuit to one of terminate the operation of the flywheel drive and generate resistance to continued rotation of the flywheel.

16. A wheel according to claim 12, wherein the separation detection mechanism comprises an optical sensor positioned in the enclosure and coupled to the control circuit, wherein the flywheel has an aperture that periodically aligns with the optical sensor when the flywheel is rotating, the optical sensor, in response to detecting a pattern of light, causing the control circuit to one of terminate the operation of the flywheel drive and generate resistance to continued rotation of the flywheel.

17. A wheel according to claim 11, further comprising a manual power button for controlling the control circuit.

18. A wheel according to claim 1, further comprising:
a flywheel drive operable to apply a torque to a drive wheel positioned against the flywheel to drive the flywheel, the drive wheel having a drive rotation axis that is generally perpendicular to the wheel rotation axis, the drive wheel having a bevelled edge; and
a bevelled surface on the flywheel generally extending along a line from an intersection point between the drive wheel rotation axis and the flywheel rotation axis, the bevelled edge of the drive wheel positioned against the bevelled surface of the flywheel along a width of the bevelled edge thereof.

19. A wheel according to claim 18, wherein at least one of the bevelled edge of the drive wheel and the bevelled surface of the flywheel is comprised of one of a rubber, a polymer and an elastomer.

20. A wheel according to claim 11, further comprising:
a position adjustment mechanism to which the flywheel drive is secured, the position adjustment mechanism positioning the flywheel drive in contact with the flywheel.

21. A wheel according to claim 20, wherein the position adjustment mechanism comprises a pivot that is generally perpendicular to the wheel rotation axis.

22. A wheel according to claim 21, wherein the position adjustment mechanism comprises a spring.

23. A wheel according to claim 22, wherein pivoting of the flywheel drive towards the flywheel is limited by a stop.

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A wheel for a human-powered vehicle, comprising:
a first cover rotatably coupled to a central axle defining a wheel rotation axis, the first cover comprising a circumferential rim structured to at least partially support a tyre thereon;
a second cover rotatably coupled to the central axle and secured to and mating with the first cover distal from the central axle to define an enclosure therebetween;
a flywheel structure positioned in the enclosure, comprising a flywheel extending from a collar rotatably coupled to the central axle enabling rotation of the flywheel generally about the wheel rotation axis, the flywheel being removable from the enclosure upon decoupling of one of the first cover and the second cover from the central axle; and
a flywheel drive positioned to drive the flywheel when the flywheel is rotatably coupled to the central axle.

40. A wheel according to claim 39, wherein the flywheel is releasably securable to the collar.

41. A wheel according to claim 40, wherein the first cover is secured to a wheel hub that is rotatably mounted on the central axle, wherein the second cover is secured to at least one of the wheel hub and the first cover, and wherein the flywheel structure is rotatably mounted on the wheel hub.

42. A wheel according to claim 39, wherein the flywheel structure is releasably coupled to the central axle.

43. A wheel according to claim 39, wherein the flywheel is releasably secured to the collar.
